(19) United States
(12) Patent Application Publication
(10) Pub. No.: US 2021/0316341 A1
(43) Pub. Date: Oct. 14, 2021

(54) METHOD AND DEVICE FOR CLEANING PRIMARY PACKAGING MEANS

(71) Applicant: Bausch + Ströbel Maschinenfabrik Ilshofen GmbH + Co. KG, Ilshofen (DE)

(72) Inventors: Werner ILÄNDER, Schwäbisch Hall (DE); Jonas LECHLER, Crailsheim (DE); Thomas BÜHLER, Wolpertshausen (DE)

(73) Assignee: Bausch + Ströbel Maschinenfabrik Ilshofen GmbH + Co. KG, Ilshofen (DE)

(21) Appl. No.: 16/972,224

(22) PCT Filed: May 16, 2019
(86) PCT No.: PCT/EP2019/062606

§ 371 Date: Dec. 4, 2020

(30) Foreign Application Priority Data
Jun. 4, 2018 (DE) 10 2018 208 753.9

(51) Int. Cl. B08B 7/02; B08B 7/00; B08B 7/04; B08B 15/04; B24C 1/00; B24C 9/00

(52) U.S. Cl. CPC B08B 7/02; B08B 7/0092; B24C 9/006; B08B 15/04; B24C 1/003; B08B 7/04

(57) ABSTRACT

A method for cleaning primary packaging means in pharmaceutical filling and/or packaging installations. The method includes a step of treating at least one surface of the primary packaging by means of blasting with carbon dioxide (CO2) snow, a step of using a gas flow for the suction extraction of substances cleaned off from the surface, and a step of filtering the gas flow comprising the substances contained in the cleaned-off substances. A related system includes a supply device for supplying liquid CO2 and compressed air to at least one nozzle designed to generate solid particles by means of expanding the liquid CO2 to be directed onto a surface to be treated, a holding device for primary packaging, a substance removal device to remove substances cleaned from at least one surface by means of a gas flow; and a filter device for the gas flow comprising the cleaned substances.

The present invention relates to a method for cleaning primary packaging in pharmaceutical filling and/or packaging installations and to a device for carrying out a method of this kind.

Packaging materials that come into direct contact with the product to be packaged are usually referred to as primary packaging. In the pharmaceutical industry, this packaging can be ampoules, carpules, injection vials and the like. It is understood that primary packaging of this kind is subject to the highest demands in terms of the cleanliness thereof both before and after they are filled. In this case it is not only important to ensure that the primary packaging is sterile, but it is also necessary, for example, for the primary packaging to be completely dry before being filled so that, for example, the concentration and dose of the active ingredients stored in the packaging cannot change as a result of pharmaceutical water still remaining inside the primary packaging.

Up to now, primary packaging of this type has generally been cleaned by means of pharmaceutical water, which is often first heated for this purpose in order to enhance its cleaning action. However, as already indicated, cleaning methods of this type are disadvantageous in that the corresponding primary packaging must subsequently be dried, which is laborious. Moreover, cleaning processes of this type are relatively energy-intensive and cost-intensive, since the pharmaceutical water used for this purpose has to be treated in a laborious and energy-intensive manner and, if appropriate, also has to be heated, since the pharmaceutical industry in particular deals with active ingredients which have to be handled with great care, for example because they can be toxic. Therefore, under certain conditions, this may result in a large amount of contaminated water, the treatment and/or disposal of which can be cost-intensive. Furthermore, when water is used on primary packaging that has a flanged edge, for example vials or carpules, this water can penetrate under the corresponding flanged edge, which can cause undesirable corrosion.

It is therefore the object of the present invention to provide an improved method for cleaning primary packaging in pharmaceutical filling and/or packaging installations which overcomes the aforementioned disadvantages of the known methods but achieves at least equivalent cleaning results.

For this purpose, the method according to the invention comprises a step of treating at least one surface of the primary packaging by means of CO₂ snow blasting, a step of suctioning off substances cleaned from the surface by means of a gas flow, and a step of filtering the gas flow which comprises the substances containing the cleaned substances. It is thanks to the inventors of the present invention that it has been found that the method of CO₂ snow blasting known from other fields of the processing industry can also be optimally used for cleaning primary packaging in the pharmaceutical industry and can replace or supplement the cleaning using pharmaceutical water that was previously used, it being possible, by means of subsequent suctioning and filtering of the cleaned substances under certain circumstances, to trap and correspondingly dispose of toxic or dangerous substances in the corresponding filter device without contaminating a large volume of water in the process.

Similarly to dry ice blasting, CO₂ snow blasting is a compressed air blasting method in which solid carbon dioxide is used as the blasting medium. CO₂ snow blasting is also very similar to dry ice blasting in terms of its mechanisms of action, but there is a significant difference in the supply of the blasting agent. Whereas in dry ice blasting the carbon dioxide is supplied already in a solid state, and therefore a continuous supply of blasting media cannot be economically provided, CO₂ snow blasting is a method that also allows continuous operation. This is because liquid carbon dioxide is removed from a storage container as a blasting agent, and is then solidified only during the actual blasting process. For this purpose, it is supplied to a compressed air blast and expanded into a solid-gas mixture in a suitable blast nozzle. The CO₂ snow particles formed in this way are bundled and accelerated by the compressed air, the low kinetic energy of these particles causing a comparatively low abrasive effect on the surface to be cleaned. It is also for this reason that CO₂ snow blasting is ideally suited for use with primary packaging in the pharmaceutical industry.

In this case, the CO₂ snow blasting can be carried out on an outer face and/or on an inner face of the primary packaging. It is understood that the outer face of the packaging can also be cleaned when the packaging is in any state where it is already sealed, whereas the inner face can of course only be cleaned in an unfilled state.

In addition, the method according to the invention can comprise a further step of treating the primary packaging by means of a different cleaning technique, for example prior wet cleaning and optionally subsequent drying. Moreover, the contamination to be removed from the packaging can comprise at least one of contamination from the process of manufacturing the packaging, microbiological contamination, cleaning agent residues and/or product residues.

According to a second aspect, the present invention relates to a device for carrying out a method according to the invention, comprising a supply device for continuously supplying liquid CO₂ and compressed air to at least one nozzle, which nozzle is designed to generate solid particles by means of expanding the liquid CO₂ and to be oriented onto the surface to be treated, the compressed air being used in particular to accelerate the CO₂ solid particles upon exiting the nozzle. The device further comprises a holding device for at least one primary packaging, and a suction or rinsing device which is designed to remove substances cleaned from the surface by means of a gas flow, and a filter device for the gas flow containing the cleaned substances.

In addition, the device according to the invention can comprise at least one displacement device which is designed to displace the at least one nozzle relative to the at least one primary packaging. In this way, for example, primary packaging can be held stationary by the holding device and the at least one nozzle can be suitably guided around the primary packaging in order to subject a large surface area or portions of said packaging to CO₂ snow blasting.

In order to be able to provide parallelization of the process in order to increase its efficiency, the device according to the invention can comprise a plurality of nozzles which can optionally be displaced individually or in groups by the at least one displacement device. Alternatively or additionally, however, the holding device can also be designed to displace and/or rotate the at least one primary packaging relative to the at least one nozzle such that, in this case for example, at least one stationary nozzle can be provided, in front of which a primary packaging can be suitably displaced and/or rotated in order to subject a large surface area or portions thereof to CO₂ snow blasting.

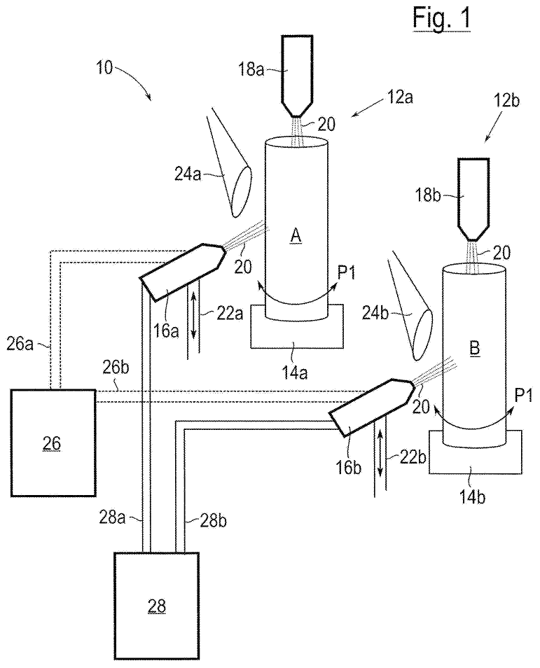

Further features and advantages of the present invention will become clear from the following description of an embodiment which is shown schematically in the accompanying FIG. 1.

In FIG. 1, a device according to the invention for cleaning primary packaging in a pharmaceutical installation is generally designated by reference sign 10. This device 10 comprises two identical cleaning stations 12a and 12b, it also being possible to provide only one or any larger number of stations in variants of a device according to the invention.

Each of the two stations 12a and 12b is provided for cleaning a relevant primary packaging which are respectively designated A and B in FIG. 1, are shown as cylindrical hollow bodies and can represent ampoules, carpules or injection vials, for example. For this purpose, each of the two stations 12a and 12b firstly comprises a relevant holding device 14a and 14b which rotatably holds the corresponding primary packaging, which is indicated by the corresponding arrows P1.

Furthermore, each of the stations has two nozzles 16a, 18a and 16b, 18b, respectively, of which the first nozzle is provided for cleaning the outer face and the second nozzle is provided for cleaning the inner face of the corresponding primary packaging A, B, and which are accordingly positioned relative to the holding devices 14a and 14b, respectively. The nozzles 16a, 16b, 18a and 18b are each CO₂ snow blast nozzles which can be designed, for example, as two-component ring nozzles. In two-component ring nozzles of this kind, liquid carbon dioxide is expanded to ambient pressure at the nozzle outlet and the resulting CO₂ snow particles are bundled and accelerated by a cover blast of supersonic compressed air, thereby forming a CO₂ snow blast 20 in each case.

It should be noted here that other carrier gases can also be used instead of compressed air, for example pure nitrogen, and therefore the carrier gas can also be formed by an inert gas.

A displacement device 22a and 22b is also associated with each of the nozzles 16a and 16b, respectively, by means of which devices said nozzles can be displaced in the longitudinal direction with respect to the primary packaging A and B relative to the holding devices 14a and 14b, as is also indicated by arrows. By operating the holding devices 14a and 14b in order to rotate the packaging A, B and the displacement devices 22a and 22b, the corresponding snow blasts 20 of the nozzles 16a and 16b can successively clean the entire outer surface of the packaging means A and B, respectively.

Finally, each of the stations 12 and 12b comprises a suction device 24a and 24b, respectively, which creates a gas flow by means of a negative pressure, by means of which gas flow substances cleaned from the primary packaging A, B can be suctioned off and transported away. In this case, a filter device (not shown) is associated with each of the suction devices 24a and 24b, through which filter device the gas flow containing the cleaned substances flows. Toxic or dangerous substances that are released while the primary packaging A and B are being cleaned can be trapped using these filter devices and disposed of by simply replacing the corresponding filters on a regular basis.

The nozzles 16a and 16b are supplied with liquid carbon dioxide and compressed air from a common source 26 for liquid carbon dioxide, for example in the form of a riser bottle, and from a common compressed air source 28, via respective feed lines 26a, 26b and 28a, 28b, respectively. It should be noted that the corresponding feed lines to the nozzles 18a and 18b are not shown in FIG. 1 merely for reasons of clarity, but that these nozzles are also supplied from the sources 26 and 28. Alternatively, however, a plurality of carbon dioxide and/or compressed air sources could of course also be provided. Moreover, a different pressurised carrier gas could be used instead of compressed air, for example pure nitrogen.

1. A method for cleaning primary packaging in pharmaceutical filling or packaging installations, comprising:
treating at least one surface of the primary packaging using carbon dioxide (CO₂) snow blasting;
using a gas flow to suctioning substances cleaned from the at least one surface by the CO₂ snow blasting; and
filtering the gas flow, the gas flow comprising the substances cleaned from the at least one surface.

2. The method of claim 1, wherein the at least one surface of the primary packaging includes one or more of an outer face and an inner face of the primary packaging.

3. The method of claim 1, further comprising treating the at least one surface of the primary packaging using an additional cleaning technique.

4. The method of claim 1, wherein the substances cleaned from the at least one surface comprise at least one of: a contamination from a process of manufacturing the primary packaging, a microbiological contamination, a cleaning agent residue, and a product residue.

5. A system for cleaning primary packaging in pharmaceutical filling and/or or packaging installations, comprising:
a supply device for supplying liquid carbon dioxide (CO2) and compressed air to at least one nozzle, wherein the at least one nozzle is designed to generate solid particles by means of expanding the liquid CO2 and to direct said solid particles onto a surface of a primary packaging;
a holding device for holding the primary packaging relative to the at least one nozzle such that the solid particles can be directed to the surface;
a substance removal device for generating a gas flow used to remove substances cleaned from the surface of the primary packaging by the solid particles; and
a filter device for filtering the removed substances from the gas flow.

6. The system of claim 5, wherein the system further comprises at least one displacement device to displace the at least one nozzle in a direction relative to the at least one primary packaging.

7. The system of claim 6, wherein the system comprises a plurality of nozzles, and wherein the nozzles can be displaced individually or in groups by the at least one displacement device.

8. The system of claim 5, wherein the holding device is configured to displace the primary packaging relative to the at least one nozzle.

9. The system of claim 5, wherein the holding device is configured to rotate the primary packaging relative to the at least one nozzle.

10. The system of claim 5, wherein the substance removal device comprises a suction device that generates the gas flow by negative pressure to suction the substances cleaned from the surface.

11. The system of claim 5, wherein the substance removal device comprises a rinsing device.

12. The system of claim 5, wherein the at least one surface of the primary packaging includes one or more of an outer face and an inner face of the primary packaging.

13. The system of claim 5, wherein the substances cleaned from the at least one surface comprise at least one of: a contamination from a process of manufacturing the primary packaging, a microbiological contamination, a cleaning agent residue and a product residue.

14. A method for cleaning primary packaging in pharmaceutical filling or packaging installations, comprising:
treating at least one surface of a primary packaging using carbon dioxide (CO2) snow blasting; and
removing substances cleaned from the at least one surface of the primary packaging using a gas flow.

15. The method of claim 14, wherein removing the substances comprises using the gas flow to rinse the substances from the at least one surface.

16. The method of claim 14, wherein removing the substances comprises generating the gas flow by negative pressure to suction the substances from the at least one surface.

17. The method of claim 14, further comprising filtering from the substances from the gas flow.

18. The of claim 14, further comprising wet cleaning the at least one surface of the primary packaging prior to treating at least one surface of the primary packaging using the CO2 snow blasting.

19. The method of claim 14, wherein the substances cleaned from the at least one surface comprise at least one of: a contamination from a process of manufacturing the primary packaging, a microbiological contamination, a cleaning agent residue and a product residue.

20. The method of claim 3, wherein the additional cleaning technique comprises at least one of:
wet cleaning the at least one surface of the primary packaging prior to treating the at least one surface of the primary packaging, and
drying the at least one surface of the primary packaging subsequent to suctioning the substances cleaned from the at least one surface.
